(19) United States
(12) Patent Application Publication
(10) Pub. No.: US 2003/0140066 A1
(43) Pub. Date: Jul. 24, 2003

(54) File identification system and method

(76) Inventor: Douglas Monahan, Austin, TX (US)

Correspondence Address: William D. Wiese, Jenkens & Gilchrist, Suite 3200, 1445 Ross Avenue, Dallas, TX, 75202, US

(21) Appl. No.: 10/325,031

(22) Filed: Dec. 20, 2002

Related U.S. Application Data
(60) Provisional application No. 60/341,372, filed on Dec. 20, 2001.

(51) Int. Cl. G06F 12/00

(52) U.S. Cl. 707/200

(57) ABSTRACT

A unique assigned code that corresponds to a prohibited file is compared to unique assigned identifiers that correspond to the individual files stored on a network or system to be scrutinized. The unique assigned identifiers do not disclose the contents of the files of the scrutinized network or systems and the examined files are not, therefore, placed on or viewable through the systems that executes the comparison. When there is a match between a unique assigned code and a unique assigned identifier, it is known that the prohibited file is resident on the examined network or system.

### PRIORITY STATEMENT UNDER 35 U.S.C. §119 & 37 C.F.R. §1.78

This non-provisional application claims priority based upon prior U.S. Provisional Patent Application Serial No. 60/341,372 filed Dec. 20, 2001 in the name of Douglas Monahan, entitled “File Identification System and Method.”

### BACKGROUND OF THE INVENTION

1. Technical Field of the Invention

The present invention relates to the identification of files and, in particular, the identification of files without examination of the literal contents of the file identified.

2. Description of Related Art

From servers around the world, digitized files are conveyed to distant stand-alone or networked computers with a few keystrokes or the click of a mouse. If not blocked by a firewall or other filter, the conveyed files are stored on media associated with the receiving computer or network. The conveyed files may include information or content that is, for any of several reasons, prohibited, protected, or undesirable in the context of the receiving computer. The structure of the received file is, however, conventional and, therefore, not amenable to interdiction by a typical firewall. Consequently, a file may end up in locations or uses that can precipitate liability for those organizations upon whose servers or computers the conveyed file resides. For example, the unauthorized actions of an individual could place images that are illegal, offensive or protected by copyright law on storage facilities of the network of a corporation that is entirely unaware of the new and unauthorized files now resident in its domain.

Removal of such unauthorized files is difficult. Confidential or trade secret data often reside in the domains in which offensive files have been stored unbeknownst to the host. Therefore, any searcher must be authorized to view the confidential materials that would inevitably be viewed during a search for offending files. At the same time, the amount of data under storage often increases dramatically over time, complicating the identification and localization of particular offensive files, even if access to the entire repository is authorized.

What is needed, therefore, is a system and method to efficiently identify unauthorized files in a data repository without compromising the confidentiality of other stored data or files.

### SUMMARY OF THE INVENTION

A unique assigned code that corresponds to a prohibited file is compared to unique assigned identifiers that correspond to the individual files stored on a network or system to be scrutinized. The unique assigned identifiers do not disclose the contents of the files of the scrutinized network or system and the examined files are not, therefore, placed on or viewable through the comparison. When there is a match between a unique assigned code and a unique assigned identifier, it is known that the prohibited file is resident on the examined network or system. With optional features, the identified prohibited file can be located and removed.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 depicts an exemplar system employed in accordance with a preferred embodiment of the present invention.; and

FIG. 2 illustrates the preferred method for file identification.

### DETAILED DESCRIPTION OF THE EXEMPLARY EMBODIMENTS OF THE INVENTION

The numerous innovative teachings of the present application will be described with particular reference to the presently preferred exemplary embodiments. However, it should be understood that these embodiments provide only a few examples of the many advantageous uses of the innovative teachings herein. In general, statements made in the specification of the present application do not necessarily delimit any of the various claimed inventions. Moreover, some statements may apply to some inventive features, but not to others.

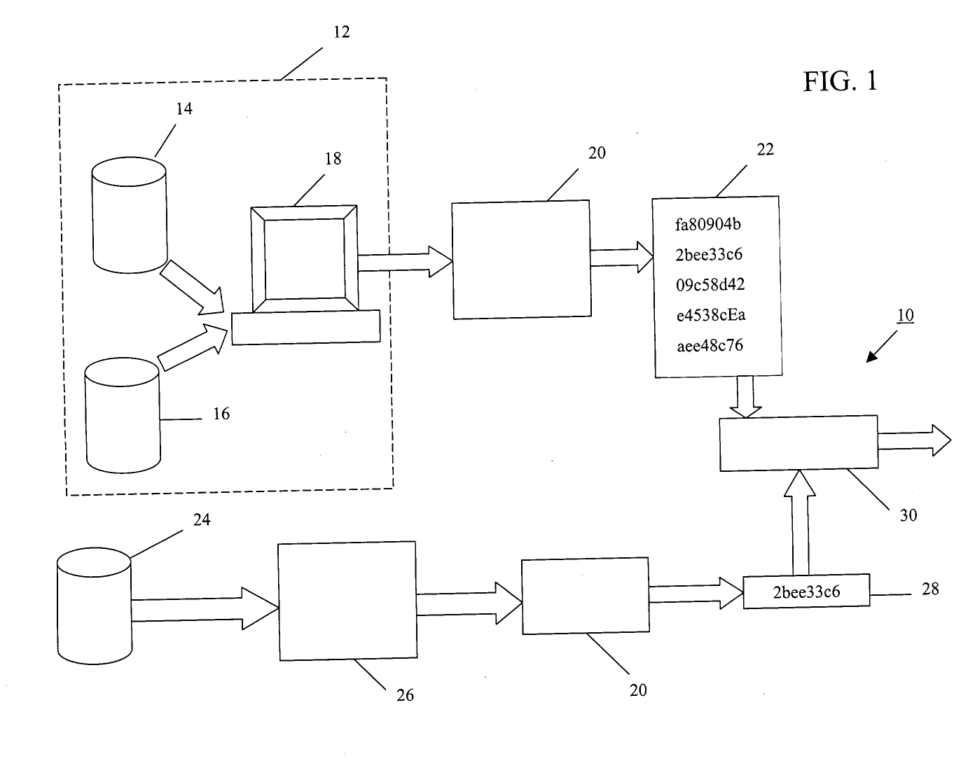

FIG. 1 is a graphical depiction of a system 10 employed in accordance with a preferred embodiment of the present invention. A general structure of system 10 is shown in use with a target computer system 12 to be examined for the presence of undesired or prohibited files. In the depiction of FIG. 1, target computer system 12 includes database 14 and disk array 16 and computer terminal 18 connected to database 14 and array 16. Target computer system 12 need not include out-lying storage such as illustrated database 14 and array 16 and may include only local or on-board storage. The present invention may be used to advantage to examine target computer systems of a variety of types with a variety of storage locations and media. Example database 14 and array 16 may be repositories of files of a multiplicity of formats that express data image, text, video, or sound formats, or may be specialized storage vehicles that contain only one or two types of files. When this application uses the term “file,” it should be understood to include digital representations of any types of information whether alpha-numeric text, visual imagery including motion or still, or auditory. It should also be understood that computer system 12 is merely exemplary and is offered to illustrate only one of the many computer systems that can be examined in accordance with the present invention. Those of skill will recognize that in addition to external storage, computer system 12 may employ on-board storage in association with terminal 18.

Files from target computer system 12 are evaluated by sum calculator 20 to produce a unique identifier that, in a preferred embodiment, is expressed in digits that correspond to the identified file. A particular preferred embodiment expresses the unique identifiers and unique codes in eight hex digits. Unique identifier listing 22 illustrates five unique identifiers for five different files including images, text, and database files. Sum calculator 20 may be any of the many checksum calculators readily available to those of skill in the art. An example sum calculator that can be employed as sum calculator 20 is WinCrc32. WinCrc32 is just one of many checksum type generators that can produce unique identifiers and unique codes for use with the present invention. Preferably, sum calculator 20 will produce a unique identifier that provides sufficient resolution to detect minute changes made in a file.

System 10 is shown with a database repository 24 of prohibited files. The system may be employed in instances where only one particular prohibited file is sought in a computer system 12 to be examined, but the availability of multiple prohibited files in a database or other storage can provide convenience for the user of the system. For clarity of depiction, FIG. 1 depicts an examination of computer system 12 for the presence of one prohibited file 26 but those of skill will recognize that the target system 12 may be examined by the disclosed process for is the presence of multiple prohibited files.

For purposes of illustration, prohibited file 26 may be deemed to be an executable file offered only to users authorized under license terms to which the owner of target computer system 12 has not subscribed. Even so, in the continuing illustration, a user of target computer system 12 has found a copy of prohibited file 26 on the Internet and loaded it onto target computer system 12 unbeknownst to the owner of target computer system 12.

Sum calculator 20 generates a unique assigned code that corresponds to prohibited file 26 and is depicted as unique assigned code “2bee33c6” in process box 28. Comparison process 30 compares the unique assigned code that corresponds to prohibited file 26 (i.e., “2bee33c6”) to the unique identifier listing 22 that includes unique identifiers that correspond to files taken from media of target computer system 12.

Those of skill will recognize that unique identifier listing 22 may include not only the unique identifiers that correspond to files in target computer system 12 but may also include location data that can be employed to locate in storage, prohibited files found in target computer system 12 by system 10. After comparing the unique assigned code that corresponds to the prohibited file 26 to the unique identifier listing 22, comparison process 30 provides an output signal 32 that includes, in a preferred embodiment, an indication of the presence of the prohibited file 26 by virtue of the detection of a unique identifier from target computer system 12 that exactly matches the unique assigned code that corresponds to the prohibited file.

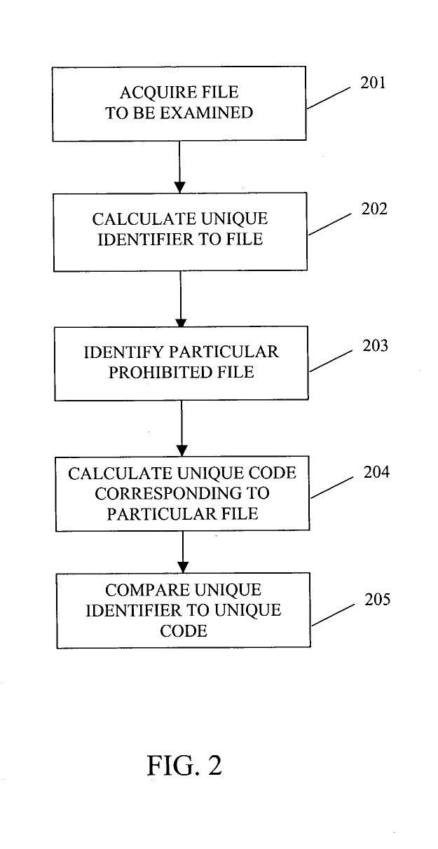

FIG. 2 is a workflow diagram showing a method employed in the preferred embodiment of the present invention. The first step is to acquire a file to be examined 201. The file to be examined 201 can be located on, for example, a target computer system. The target computer system can include, for example, a database, disk array, and computer terminal connected to the database and disk array. The target computer system need not include outlying storage such as a remote database or disk array but may include, for example, only local or onboard storage. The files to be examined 201 may include digital representations such as alpha numeric text, moving visual imagery, still visual imagery and auditory representations. The format of the files to be examined 201 may be in data image, text, video or audio format.

Next, a unique identifier is calculated 202. The method of calculating the unique identifier 202 may be performed by a sum calculator to produce a unique identifier that, in the preferred embodiment, is expressed in digits that correspond to the identified file. A particular preferred embodiment expresses the unique identifiers in 8-hex digits. The sum calculator may be any check sum calculator readily available to those of skill in the art. Preferably, the check sum calculator will produce a unique identifier that provides sufficient resolution to detect minute changes made in a file.

Next, a particular prohibited file is identified 203. There may be instances where only one particular prohibited file is sought to be identified, but it may also be possible to identify multiple files. The preferred embodiment also provides that a repository of prohibited files may be retained for comparison purposes. The prohibited file may be, for example, an executable file offered only to users authorized under licensed terms to which the file to be examined is not bound.

Next, the check sum calculator generates a unique assigned code that corresponds to the particular prohibited file 204. Thereafter, the unique code is compared to the unique identifier 205. The unique identifier is configured so as not to disclose the contents of the file to be examined. In addition, during the comparison process, the file to be examined is not viewable.

Once the unique identifier has been compared to the unique code 205, those with skill in the art will recognize that a signal can be generated to indicate the presence of a particular file on the target computer system. Alternatively, a signal could be generated upon the occurrence of a match between the unique identifier and the unique code. Once a match occurs, an additional step may be included in which the location of the particular file on the target computer system is recorded and vocation is indicated to the user. Thereafter, an additional step may be incorporated in which the particular prohibited file is removed from the system.

I claim:

1. A method for determining if a particular file is present on a storage media, the method comprising the steps of:
acquiring a file to be examined stored on a digital storage media;
calculating a unique identifier corresponding to said file to be examined;
acquiring a particular file, the presence of which on said digital storage media is to be determined;
calculating a unique code corresponding to said particular file; and
comparing said unique identifier corresponding to said file to be examined and said unique code corresponding to said particular file.

2. The method of claim 1 wherein said digital storage media includes a database, a disk array and a computer terminal.

3. The method of claim 1 wherein said file to be examined is in a format selected from the group consisting of data images, text, video and audio.

4. The method of claim 1 wherein said file to be examined includes digital representation selected from the group consisting of alpha-numeric text, moving visual imagery, still visual imagery and auditory.

5. The method of claim 1 wherein said method for calculating said unique identifier corresponding to said file to be examined expresses said unique identifier in digits corresponding to said file to be examined.

6. The method of claim 1 wherein said method for calculating said unique identifier corresponding to said file to be examined expresses said unique identifier in 8-hex digits.

7. The method of claim 1 wherein said particular file is an executable file offered only to users under a license agreement to which said file to be examined is not bound.

8. The method of claim 1 further providing the step of storing a repositiory of said particular files.

9. The method of claim 1 wherein said unique identifier is configured so as not to disclose the contents of said file to be examined.

10. The method of claim 1 wherein said file to be examined is not viewable during said comparison.

11. The method of claim 1 further comprising the step of generating a signal indicative of the presence of said particular file on said digital storage media from which said file to be examined was acquired.

12. The method of claim 1 further comprising the step of generating a signal indicative of a match between said unique identifier and said unique code.

13. The method of claim 1 further comprising the step of recording the location on said digital storage media from which said file to be examined was acquired.

14. The method of claim 13 further comprising the step of indicating said location from which said file to be examined was acquired.

15. The method of claim 1 further comprising the step of removing said file to be examined if said unique identifier corresponding to said file to be examined matches said unique code corresponding to said particular file.

16. The method of claim 1 wherein said unique identifier includes location data that can be used to locate said particular file.

17. A system for determining if a particular file is present on a storage media, the system comprising:
means for acquiring a file to be examined stored on a digital storage media;
means for calculating a unique identifier corresponding to said file to be examined;
means for acquiring a particular file, the presence of which on said digital storage media is to be determined;
means for calculating a unique code corresponding to said particular file; and
means for comparing said unique identifier corresponding to said file to be examined and said unique code corresponding to said particular file.

18. The system of claim 17 wherein said digital storage media includes a database, a disk array and a computer terminal.

19. The system of claim 17 wherein said file to be examined is in a format selected from the group consisting of data images, text, video and audio.

20. The system of claim 17 wherein said file to be examined includes digital representation selected from the group consisting of alpha-numeric text, moving visual imagery, still visual imagery and auditory.

21. The system of claim 17 wherein said means for calculating said unique identifier corresponding to said file to be examined expresses said unique identifier in digits corresponding to said file to be examined.

22. The system of claim 17 wherein said means for calculating said unique identifier corresponding to said file to be examined expresses said unique identifier in 8-hex-digits.

23. The system of claim 17 wherein said particular file is an executable file offered only to users under a license agreement to which said file to be examined is not bound.

24. The system of claim 17 further providing a means for storing a repository of said particular files.

25. The system of claim 17 wherein said unique identifier is configured so as not to disclose the contents of said file to be examined.

26. The system of claim 17 wherein said file to be examined is not viewable during said comparison.

27. The system of claim 17 further comprising means for generating a signal indicative of a match between said unique identifier and said unique code.

28. The system of claim 17 further comprising means for generating a signal indicative of the presence of said particular file on said digital storage media from which said file to be examined was acquired.

29. The system of claim 17 further comprising means for recording the location on said digital storage media from which said file to be examined was acquired.

30. The system of claim 29 further comprising means for indicating said location from which said file to be examined was acquired.

31. The system of claim 17 further comprising means for removing said file to be examined if said unique identifier corresponding to said file to be examined matches said unique code corresponding to said particular file.

32. The system of claim 17 wherein said unique identifier includes location data that can be used to locate said particular file.
